(19) United States
(12) Patent Application Publication
(10) Pub. No.: US 2021/0258438 A1
(43) Pub. Date: Aug. 19, 2021

(54) APPARATUS, CONTROL METHOD THEREOF, AND STORAGE MEDIUM

(71) Applicant: Canon Kabushiki Kaisha, Tokyo (JP)

(72) Inventors: Atsushi Ikeda, Ibaraki (JP); Hiroaki Koike, Tokyo (JP); Takeshi Kogure, Ibaraki (JP)

(21) Appl. No.: 17/174,525

(22) Filed: Feb. 12, 2021

(30) Foreign Application Priority Data
Feb. 13, 2020 (JP) 2020-022175

(51) Int. Cl. H04N 1/00; G06F 3/0481; G06F 3/0486

(52) U.S. Cl. CPC H04N 1/00506; H04N 1/00424; G06F 3/0486; G06F 3/04817

(57) ABSTRACT

An object of the present invention is to indicate one or more rearrangement-target icons to a user without producing an animation display in a case where icon rearrangement is performed by the drag and drop operation. One embodiment of the present invention is an apparatus including: a derivation unit configured to derive one or more icons different from a first icon, which are rearrangement targets in a case where the drop operation is performed for the first icon during the drag operation of the first icon among icons displayed on a display unit; and a display control unit configured to perform control so that the display unit additionally displays a first mark for the one or more icons derived by the derivation unit.

### BACKGROUND OF THE INVENTION

### Field of the Invention

The present invention relates to a technique to rearrange icons displayed on a screen.

### Description of the Related Art

Conventionally, a technique is known that rearranges the display positions of icons by moving into an editing mode by holding down an icon being displayed on a screen and performing the drag and drop operation for the icon during the editing mode in a smartphone and the like. Japanese Patent Laid-Open No. 2009-146334 has disclosed a method of exchanging, in a case where an icon is overlapped on another icon by performing the drag and drop operation, the display positions of the respective icons. A smartphone is designed with a new idea so that a user is notified visually of how the arrangement of each icon changes accompanying the drop of an icon during the drag operation of the icon. Specifically, the main idea is that during the drag of an icon, one or more other icons that are to be rearranged accompanying the movement of the icon are rearranged and displayed each time while showing the progress, that is, a so-called animation display of icons. However, for example, a comparatively inexpensive MFP has a limit of the processing capability of hardware, and therefore, in a case where an animation display is produced during the drag of an icon, there is such a problem that the responsiveness to the drag operation is degraded and it is desirable not to produce an animation display. Because of this, in Japanese Patent Laid-Open No. 2009-146334, no animation display is produced during the drag of an icon.

### SUMMARY OF THE INVENTION

However, Japanese Patent Laid-Open No. 2009-146334 has such a problem that the rearrangement-target icon is only one icon that is to be exchanged separate from the icon being dragged and it is not possible to indicate a plurality of rearrangement-target icons to a user.

Consequently, in view of the above-described problem, an object of one embodiment of the present invention is to indicate one or more rearrangement-target icons separate from the icon being dragged to a user.

One embodiment of the present invention is an apparatus including: a derivation unit configured to derive one or more icons different from a first icon, which are rearrangement targets in a case where a drop operation is performed for the first icon during a drag operation of the first icon among icons displayed on a display unit; and a display control unit configured to perform control so that the display unit additionally displays a first mark for the one or more icons derived by the derivation unit.

Further features of the present invention will become apparent from the following description of exemplary embodiments with reference to the attached drawings.

### BRIEF DESCRIPTION OF THE DRAWINGS

FIG. 1 is a block diagram showing a hardware configuration of an MFP 10 in a first embodiment;

FIG. 2 is a block diagram showing a software configuration of the MFP 10 in the first embodiment;

FIG. 3A and FIG. 3B are each a HOME screen of the MFP 10 in the first embodiment;

FIG. 4A and FIG. 4B are each a diagram showing a display order setting screen;

FIG. 5A is a diagram showing results of dropping an icon on a screen 410 in FIG. 4B and FIG. 5B is a diagram showing a screen that is displayed in a case where a Settle button is pressed down after that;

FIG. 6A and FIG. 6B are each a diagram showing a screen that is displayed in a case where a tapped-in icon is dragged across pages;

FIG. 7 is a diagram showing a case where a page switching operation is performed in the state of the screen 610 in FIG. 6B and a screen 700 is displayed as the second page;

FIG. 8A and FIG. 8B are each a diagram showing a display order setting screen during drag in another embodiment;

FIG. 9 is a diagram showing a data structure for managing the display order of icons on the HOME screen in the first embodiment;

FIG. 10 is a flowchart of processing in a case where an icon of the MFP 10 is pressed down in the first embodiment;

FIG. 11 is a diagram showing the relationship between FIG. 11A and FIG. 11B;

FIG. 11A and FIG. 11B indicate a detailed flowchart of display order setting processing in the first embodiment;

FIG. 12 is a diagram showing the relationship between FIG. 12A and FIG. 12B;

FIG. 12A and FIG. 12B indicate a detailed flowchart of rearrangement-target icon selection processing in the first embodiment;

FIG. 13 is a diagram showing a data structure storing information on rearrangement-target icons, which is generated in the rearrangement-target icon selection processing;

FIG. 14 is a detailed flowchart of duplicated display order array updating processing in the first embodiment; and

FIG. 15 is a diagram showing a data structure storing information on rearrangement-target icons, which is generated in the rearrangement-target icon selection processing.

### DESCRIPTION OF THE EMBODIMENTS

In the following, with reference to the drawings, embodiments of the present invention are explained in detail. The following embodiments are not intended to limit the present invention according to the claims and all combination of features explained in the following embodiments are not necessarily indispensable to the solution of the invention.

### First Embodiment

### <Hardware Configuration of MFP 10>

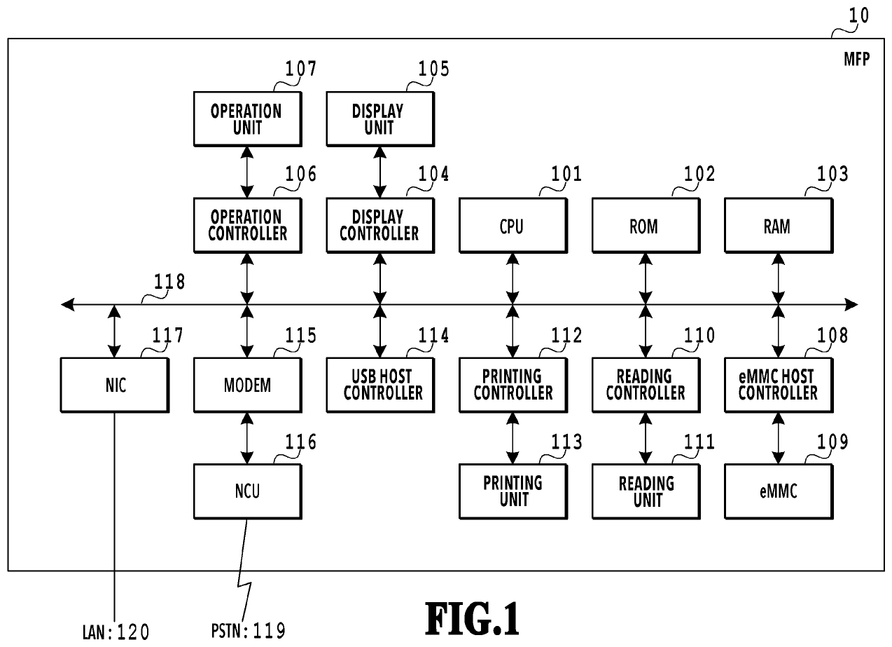

In the following, the hardware configuration of the MFP (Multifunction Peripheral) 10 in the present embodiment is explained by using FIG. 1. FIG. 1 is a bock diagram showing the hardware configuration of the MFP 10.

As shown in FIG. 1, the MFP 10 has a CPU 101, a ROM 102, a RAM 103, a display controller 104, a display unit 105, an operation controller 106, and an operation unit 107. Further, the MFP 10 has an eMMC host controller 108, an eMMC 109, a reading controller 110, a reading unit 111, a printing controller 112, and a printing unit 113. Furthermore, the MFP 10 has a USB host controller 114, a MODEM 115, a network control unit (NCU) 116, and a network interface card (NIC) 117.

The CPU 101 controls each device connected to a system bus 118. In a case where an electric power source is supplied to the MFP 10, the CPU 101 executes a boot program stored in the ROM 102. In a case where the CPU 101 executes the boot program, a main program stored in the storage (eMMC 109) is loaded onto the RAM 103 and the CPU 110 executes the loaded main program.

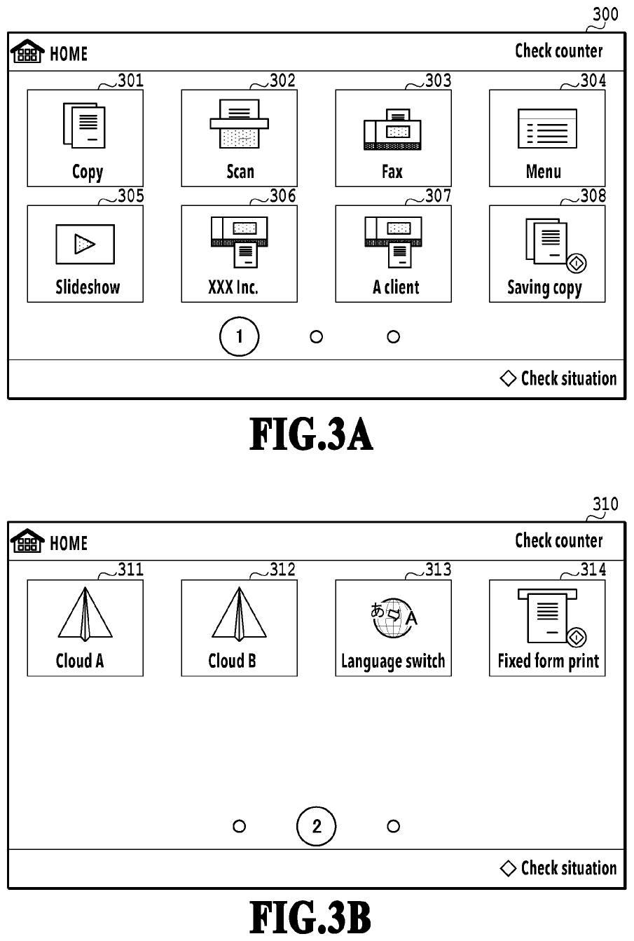

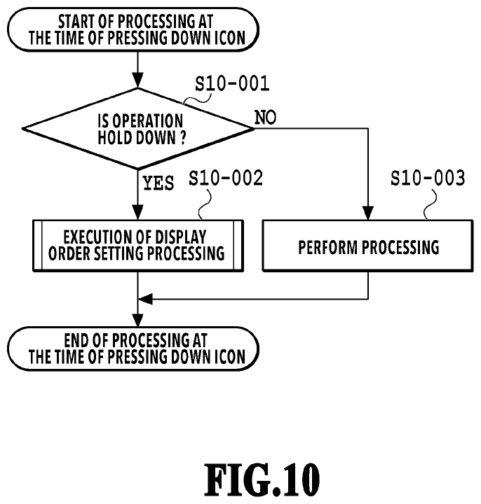

The RAM 103 functions as a work area and the like of the main program, not only as the loading position of the main program. The CPU 101 causes the display unit 105 to display each screen shown in FIG. 3A to FIG. 8B by performing each piece of processing shown in FIG. 10 to FIG. 12 and FIG. 14.

The display controller 104 controls drawing in the display unit 105. The display unit 105 is a full bitmap LCD of the WVGA size. The operation controller 106 controls the input in the operation unit 107. The operation unit 107 includes a touch panel provided so as to overlap the display unit 105.

The reading unit 111 is a unit for reading a document. To the reading unit 111, an auto document feeder (not shown schematically) is attached as an option and it is possible to automatically read a plurality of documents continuously. The reading unit 111 is connected to the reading controller 110 and the CPU 101 performs transmission and reception of data with the reading unit 111 via the reading controller 110.

The printing unit 113 forms an image on a printing medium by the electrophotographic method. The printing unit 113 is connected to the printing controller 112 and the CPU 101 performs transmission and reception of data with the printing unit 113 via the printing controller 112.

The USB host controller 114 is in charge of the USB protocol control and acts as an intermediary in access of the CPU 101 to a USB device, such as a USB memory (not shown schematically).

The MODEM 115 performs modulation and demodulation of a signal necessary for facsimile communication. Further, the MODEM 115 is connected to the NCU 116 and a signal modulated in the MODEM 115 is sent out to a public switched telephone network (PSTN 119) via the NCU 116.

The NIC 117 performs transmission and reception of data in a bidirectional manner with a mail server, a file server and the like via a LAN 120. Further, the NIC 117 performs transmission and reception of data in a bidirectional manner also with a Web server and the like.

The MFP 10 in the present embodiment has the eMMC 109 as a storage. The CPU 101 accesses the eMMC 109 via the eMMC host controller 108.

### <Software Configuration of MFP 10>

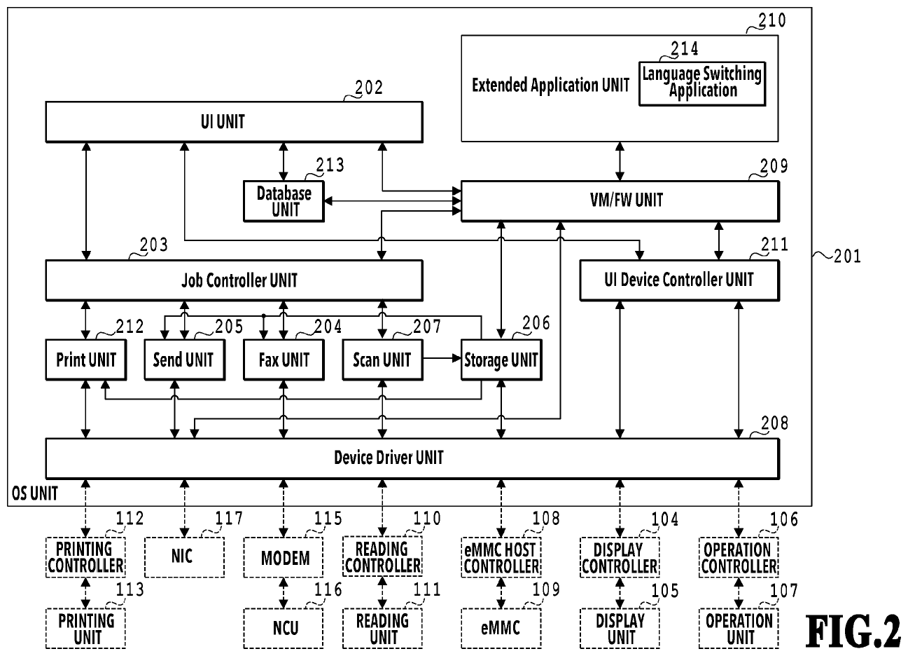

In the following, the software configuration of the MFP 10 in the present embodiment is explained by using FIG. 2. FIG. 2 is a block diagram showing the software configuration of the MFP 10. Each unit indicated by a solid line in FIG. 2 is a software module that is implemented by the CPU 101 executing the main program loaded onto the RAM 103 by the CPU 101 executing the boot program.

In a case where the CPU 101 executes the main program, each software module, to be described later, is implemented under management and control by an OS (Operating System) unit 201. In the OS unit 201, a Device Driver unit 208 is combined. The Device Driver unit 208 acts as an intermediary in transmission and reception between each software module and a hardware device, such as the display controller 104, the operation controller 106, and the reading controller 110.

A UI (User Interface) unit 202 provides various kinds of information to a user via the display unit 105. Further, the UI unit 202 receives various instructions by a user via the operation unit 107. Further, the UI unit 202 can change various settings to switch the behaviors of the MFP 10. The contents relating to the various settings changed by the UI unit 202 are stored in the eMMC 109 by a Database unit 213. As one of the various settings changed by the UI unit 202, mention is made of, for example, setting of display language.

A Job Controller unit 203 receives each job, such as copy, print, and fax, and controls the execution of the received job.

A Storage unit 206 is a software module that stores and manages, for example, an image that is transmitted and received by a facsimile and data of the setting and the like of an application requested from an extended application unit 210 in the eMMC 109. For example, in a case where the Job Controller unit 203 receives a fax transmission job in the MFP 10 of the present embodiment, a Scan unit 207 having received the job request scans a document by controlling the reading unit 111. Then, the Storage unit 206 stores the scanned facsimile image data in the eMMC 109. The facsimile image data stored in the eMMC 109 is read by a Fax unit 204 and transmitted to a destination by a facsimile via the MODEM 115 and NCU 116. Further, for example, in a case where image data is received by a facsimile from a destination via the MODEM 115 and NCU 116, the received image data is taken in by the Fax unit 204. Then, the Storage unit 206 stores the taken-in image data in the eMMC 109.

A VM (Virtual Machine)/FW (Framework) unit 209 has a role to install an arbitrary program described in script language or predetermined high-level programming language in the extended application unit 210. Further, the VM/FW unit 209 also has a role to uninstall an arbitrary program from the extended application unit 210. Further, the VM/FW unit 209 also has a role to perform arbitration and the like between a function implemented by an arbitrary program installed in the extended application unit 210 and an already-existing function. Further, the VM/FW unit 209 interprets and executes the described script language.

The extended application unit 210 includes arbitrary programs and the like described in script language. This arbitrary program may be described by using a language system, such as Java (registered trademark), which is an interpreter that analyzes and executes a byte code, and Lua.

By these software modules, it is possible for the MFP 10 to easily implement an arbitrary function, for example, such as a Language Switching Application 214, while maintaining attachability/detachability of the function. Further, the VM/FW unit 209 acts as an intermediary in a request from an arbitrary program installed in the extended application unit 210 and as a result of that, the Database unit 213 refers to, changes, and so on the various setting values. In the present embodiment, the extended application unit 210 is not indispensable.

A UI Device Controller unit 211 acts as an intermediary in that the UI unit 202 and the extended application unit 210 output various kinds of information to the display unit 105. Further, the UI Device Controller unit 211 acts as an intermediary in transmitting the user operation via the operation unit 107 to the UI unit 202 and the extended application unit 210.

A Send unit 205 transmits data stored in the eMMC 109 to the outside via the MODEM 115 and the NCU 116. A Print unit 212 causes the printing unit 113 to perform printing processing via the printing controller 112.

### <HOME Screen of MFP 10>

In the following, an example of the HOME screen of the MFP 10 in the present embodiment is explained by using FIG. 3A and FIG. 3B. FIG. 3A and FIG. 3B are each a diagram showing an example of the HOME screen of the MFP 10.

The HOME screen shown in FIG. 3A and FIG. 3B is generated by the CPU 101 executing the program configuring the UI unit 202 in FIG. 2 and displayed on the display unit 105 via the UI Device Controller unit 211 and the display controller 104.

The HOME screen includes a plurality of pages and on one page of the HOME screen, up to four icons are displayed in the upper row and the lower row, respectively. In the example shown in FIG. 3A, on a first page 300, eight icons, that is, an icon 301 to an icon 308 are displayed and in the example shown in FIG. 3B, on a second page 310, four icons, that is, an icon 311 to an icon 314 are displayed.

### <Data Structure Managing Display Order of Icons>

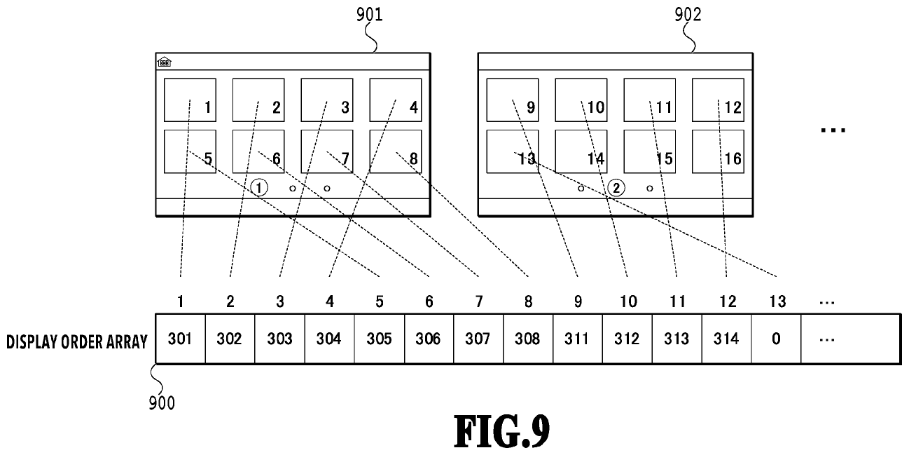

In the following, a display order array 900 that manages the display order of icons on the HOME screen of the MFP 10 of the present embodiment is explained by using FIG. 9. FIG. 9 is a diagram showing a data structure that manages the display order of icons on the HOME screen.

In the MFP 10, the display order of icons on the HOME screen is managed by using the display order array 900, which is a simple one-dimensional array.

On the HOME screen and the display order setting screen, the area in which an icons is displayed is referred to as an icon area. As shown in FIG. 9, as the value indicating each icon area, in the upper row on a first page 901, the areas in order from the leftmost area are taken as an area 1 to an area 4 and in the lower row, the areas in order from the leftmost area are taken as an area 5 to an area 8. Similarly, in the upper row on a second page 902, the areas in order from the leftmost area are taken as an area 9 to an area 12 and in the lower row, the areas in order from the leftmost area are taken as an area 13 to an area 16. On the subsequent pages, the values indicating the icon area are allocated in order from the leftmost area in the upper row to the rightmost area in the lower row.

Each icon is provided with the number indicating each individual icon. As shown in FIG. 9, first, the numbers indicating the four icons that are arranged in the area 1 to the area 4 in the upper row on the first page 901 are stored in order from the top of the display order array 900. Next, the numbers indicating the four icons in the area 5 to the area 8 in the lower row on the first page 901 are stored in order from fifth position from the top of the display order array 900. Following the above, the numbers indicating the four icons in the area 9 to the area 12 in the upper row on the second page 902 on the HOME screen are stored in order from the ninth position from the top of the display order array 900. Further, following the above, the numbers indicating the four icons in the area 13 to the area 16 in the lower row on the second page 902 on the HOME screen are stored in order from the 13th position from the top of the display order array 900. After this, in the same order, the numbers indicating icons that are arranged in respective areas are stored in order in the display order array 900.

In FIG. 9, the numbers indicating the icon 301 to the icon 308 on the first page 300 on the HOME screen shown in FIG. 3A and the numbers indicating the icon 311 to the icon 314 on the second page 310 on the HOME screen shown in FIG. 3B are stored in order from the top of the display order array 900. Here, 0 that is stored in the 13th position from the top of the display order array 900 means a blank (that is, blank on the HOME screen, in which no icon exists). As the number indicating each ion shown in FIG. 9, for convenience, the symbol attached to each icon in FIG. 3A and FIG. 3B is used, but as long as it is possible to identify each individual icon, quite different values may be used.

### <Flowchart of Processing at the Time of Pressing Down Icon>

In the following, processing at the time of pressing down an icon of the MFP 10 in the present embodiment is explained by using FIG. 10. FIG. 10 is a flowchart of the processing at the time of pressing down an icon of the MFP 10.

By the CPU 101 executing a part of the programs configuring the UI unit 202 in FIG. 2, the processing in FIG. 10 is performed. In a case where a user operates the operation unit 107, information on the coordinate position on the screen on which the operation has been performed and operation contents and the like, such as tap in, tap out, hold down, flick, and drag, is transmitted to the UI unit 202 via the UI Device Controller unit 211. In a case where the received information is information on the operation for the icon area, the UI unit 202 calls the processing in FIG. 10. In the present embodiment, the operation of a user touching the operation unit 107 is referred to as tap in. Further, the operation of a user moving from the state where a user is in touch with the operation unit 107 to the state of non-touch is referred to as tap out. Furthermore, the operation to perform tap in and tap out on the same coordinates on the screen is referred to as press down.

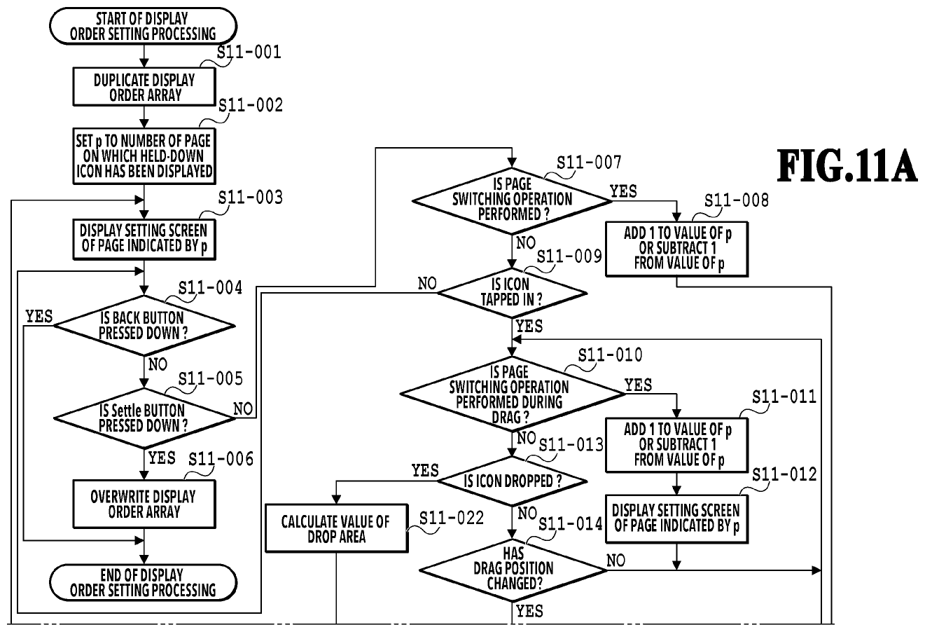

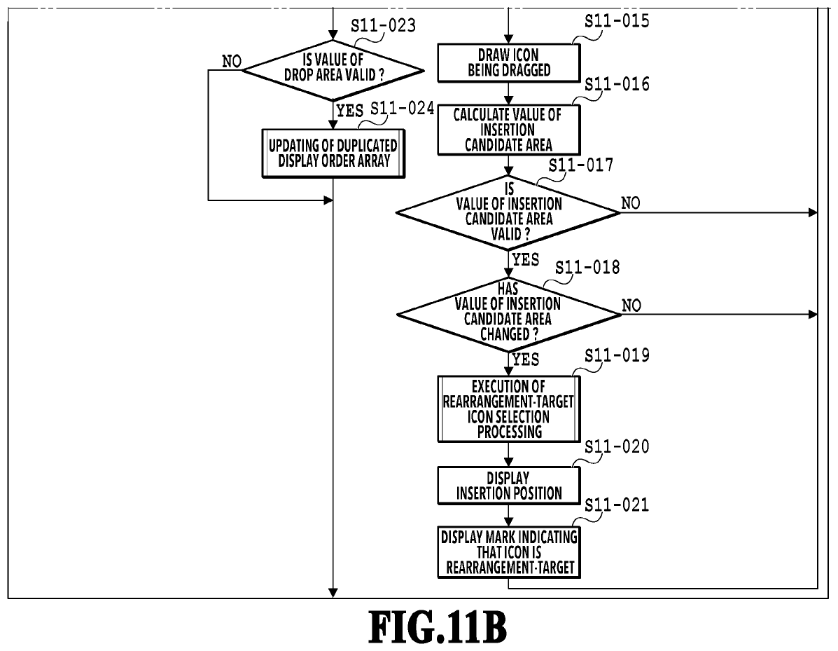

At step S10-001, the CPU 101 determines whether the operation for the icon area by a user is hold down. In a case where the determination results at this step are affirmative, the processing advances to step S10-002 and the display order setting processing is performed. Details of the display order setting processing will be described later (see FIG. 11). On the other hand, in a case where the determination results at this step are negative, the processing advances to step S10-003 and the relevant processing is performed for the pressed-down icon. This processing does not relate directly to the present embodiment, and therefore, explanation is omitted. In the following, “step S-” is abbreviated to “S-”.

### <Flowchart of Display Order Setting Processing>

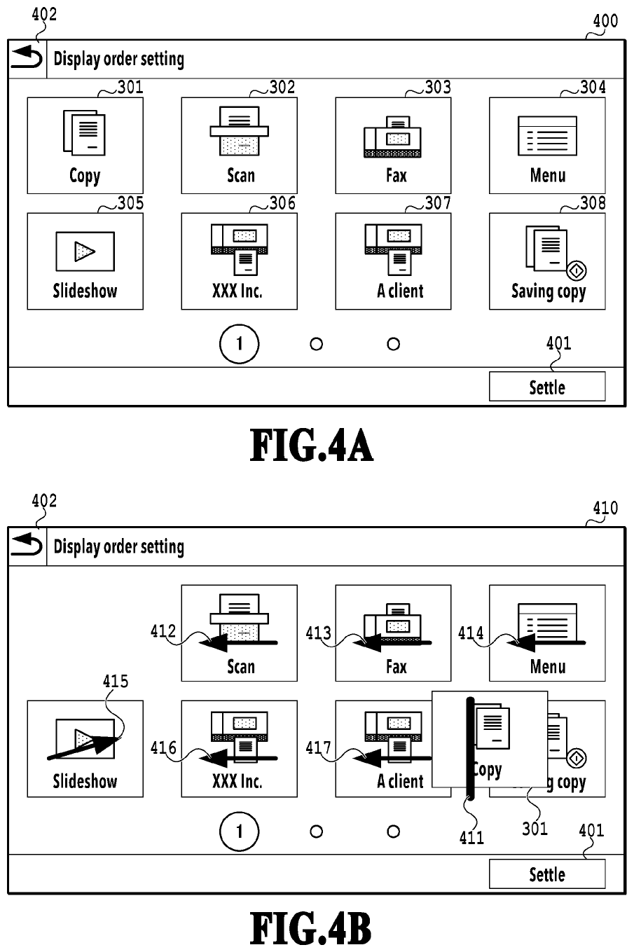

In the following, the display order setting processing that is performed at S10-002 is explained by using FIG. 4A and FIG. 4B and FIG. 11. FIG. 4A and FIG. 4B are each a diagram showing an example of the display order setting screen that is displayed on the display unit 105 by the processing in FIG. 11. Further, FIG. 11 is a detailed flowchart of the display order setting processing that is performed at S10-002. As shown in FIG. 4A, on the display order setting screen in the present embodiment, like the HOME screen shown in FIG. 3A and FIG. 3B, eight icons are displayed on one page. By the CPU 101 executing a part of the programs configuring the UI unit 202 in FIG. 2, the processing in FIG. 11 is performed.

First, at S11-001, the CPU 101 generates a duplicate of the display order array 900 in FIG. 9 and temporarily stores the duplicate in the RAM 103.

At S11-002, the CPU 101 sets a parameter p (referred to as target page number) indicating the target page for which the display order is set to the number of the page on which the icon determined to be held down at S10-001 in FIG. 10 has been displayed.

At S11-003, the CPU 101 displays the display order setting screen of the page indicated by p. A screen 400 in FIG. 4A is an example of the screen that is displayed at S11-003. The screen 400 is the display order setting screen that is displayed in a case where the page indicated by p is the first page 300 in FIG. 3A. As shown in FIG. 4A, the display order setting screen has a Settle button 401 and a back button 402. At S11-004, the CPU 101 determines whether the back button 402 is pressed down. In a case where the determination results at this step are affirmative, the display order setting processing is terminated. On the other hand, in a case where the determination results at this step are negative, the processing advances to S11-005.

At S11-005, the CPU 101 determines whether the Settle button 401 is pressed down. In a case where the determination results at this step are affirmative, the processing advances to step S11-006. On the other hand, in a case where the determination results at this step are negative, the processing advances to S11-007.

At S11-006, the CPU 101 writes the display order array duplicated at S11-001 over the original display order array 900 (that is, overwrites) and terminates the display order setting processing. In a case where this step is performed after S11-24, to be described later, in the display order array 900, the display order of the numbers indicating icons is rearranged.

At S11-007, the CPU 101 determines whether the page switching operation is performed. In the MFP 10 in the present embodiment, in a case where the flock operation or the drag operation from left to right is performed for a blank portion between icons, it is possible to switch the page that is displayed on the screen to the previous page in accordance with the operation. Further, in a case where the flick operation or the drag operation from right to left is performed, it is possible to switch the page that is displayed on the screen to the next page. In a case where the determination results at this step are affirmative, the processing advances to S11-008. On the other hand, in a case where the determination results at this step are negative, the processing advances to S11-009.

At S11-008, the CPU 101 changes the target page for which the display order is set to the previous page or the next page of the current page. Specifically, the CPU 101 adds 1 to the value of p or subtracts 1 from the value of p.

At S11-009, the CPU 101 determines whether an icon is tapped in. In a case where the determination results at this step are affirmative, the processing advances to S11-010. On the other hand, in a case where the determination results at this step are negative, the processing returns to S11-004.

At S11-010, the CPU 101 determines whether the page switching operation is performed during the drag of an icon. In the MFP 10 in the present embodiment, in a case where the operation is stopped temporarily at the blank portion at the leftmost end on the screen in the state where an icon is being dragged, it is possible to switch the page that is displayed on the screen to the previous page. Further, in a case where the operation is stopped temporarily at the blank portion at the rightmost end on the screen in the state where an icon is being dragged, it is possible to switch the page that is displayed on the screen to the next page. In a case where the determination results at this step are affirmative, the processing advances to S11-011. On the other hand, in a case where the determination results at this step are negative, the processing advances to S11-013.

At S11-011, the CPU 101 changes the target page for which the display order is set to the previous page or the next page of the current page. Specifically, the CPU 101 adds 1 to the value of p or subtracts 1 from the value of p.

At S11-012, as at S11-003, the CPU 101 displays the display order setting screen of the page indicated by p and the processing returns to S11-010.

At S11-013, the CPU 101 determines whether the icon being dragged is dropped. In a case where the determination results at this step are affirmative, the processing advances to step S11-022. On the other hand, in a case where the determination results at this step are negative, the processing advances to S11-014.

At S11-014, the CPU 101 determines whether the drag position has changed. In a case where the determination results at this step are affirmative, the processing advances to S11-015. On the other hand, in a case where the determination results at this step are negative, the processing returns to S11-010.

At S11-015, the CPU 101 draws the icon being dragged. Specifically, the CPU 101 deletes the icon image by displaying the background image at the position at which the icon image was drawn the previous time and draws the same icon image as the icon image that is deleted at a new position.

At S11-016, the CPU 101 finds the value of an insertion candidate area of the icon being dragged by performing computing. For example, in the first page 901 in the FIG. 9, a case is studied where the value of the insertion candidate area is within the range of the values indicating the icon areas in the lower row and the position in the horizontal direction of the insertion candidate area is to the right of the center of the area 6 and to the left of the center of the area 7. In this case, the value of the insertion candidate area is between the value (=6) of the area 6 and the value (=7) of the area 7, and therefore, the value of the insertion candidate area is taken to be 6.5. In a case where the value of the insertion candidate area does not belong to within the range of the values indicating the icon areas in the upper row or within the range of the values indicating the icon areas in the lower row, the computing of the value of the insertion candidate area is invalid. In this case, the value of the insertion candidate area is taken to be 0. Further, in a case also where the absolute value of the difference between the value of the area in which the icon is tapped in (called selected area) and the value of the insertion candidate area does not exceed 1, the computing of the value of the insertion candidate area is invalid and the value of the insertion candidate area is 0.

At S11-017, the CPU 101 determines whether the computing of the value of the insertion candidate area is valid (that is, whether the value of the insertion candidate area is not 0). In a case where the determination results at this step are affirmative, the processing advances to S11-018. On the other hand, in a case where the determination results at this step are negative, the processing returns to S11-010. At this time, in a case where marks are displayed, which indicate the insertion position displayed at S11-020, to be described later, and that the icon is a rearrangement-target icon that is displayed at S11-021, the CPU 101 deletes those marks.

At S11-018, the CPU 101 determines whether the value of the insertion candidate area has changed. Specifically, the CPU 101 determines whether the value of the insertion candidate area has changed by determining whether the insertion position is not displayed even once at step S11-020, to be described later, or comparing the insertion candidate area indicated by the insertion position displayed at S11-020 and the insertion candidate area indicated by the value of the insertion candidate area, which is found at S11-016. In a case where the determination results at this step are affirmative, the processing advances to S11-019. On the other hand, in a case where the determination results at this step are negative, the processing returns to S11-010.

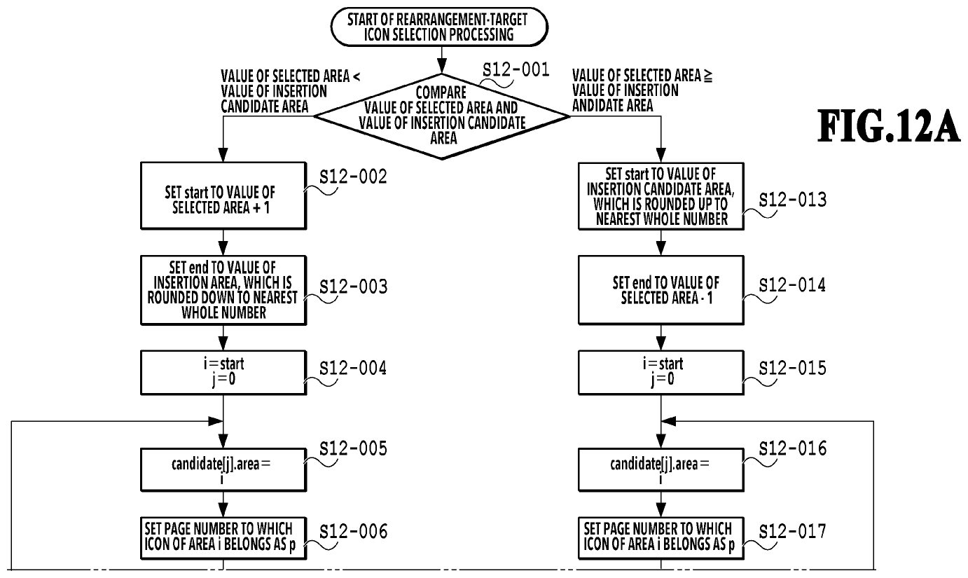

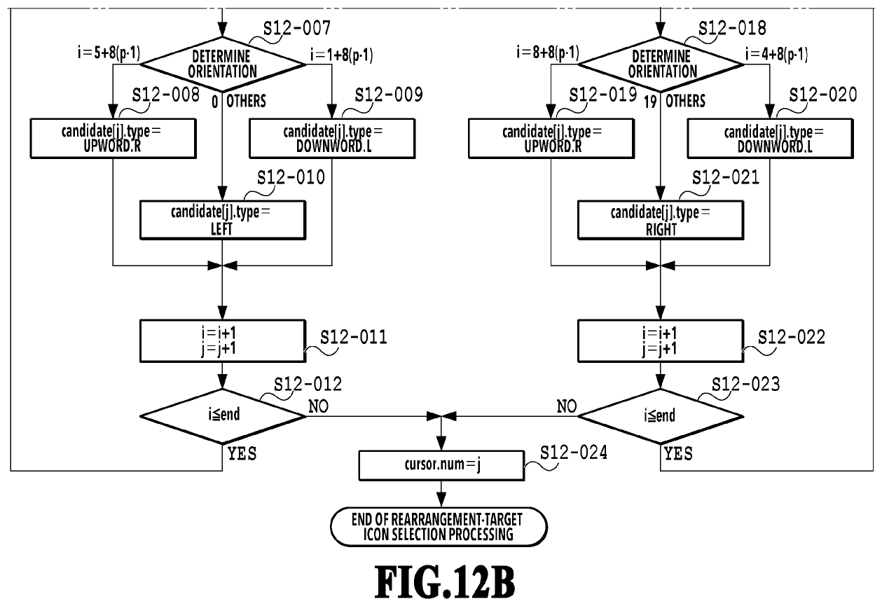

At S11-019, the CPU 101 performs the rearrangement-target icon selection processing. Details of the rearrangement-target icon selection processing will be described later (see FIG. 12).

At S11-020, the CPU 101 displays a mark for indicating the insertion position of the icon being dragged to a user. In the present embodiment, as the mark indicating the insertion position, a vertical rod is displayed. In FIG. 4B, a vertical rod 411 that is displayed at S11-020 is shown.

At S11-021, the CPU 101 displays an arrow as a mark indicating that the icon is a rearrangement target to one or more icons that are rearranged in a case where the icon being dragged is dropped at the insertion position and the processing returns to step S11-010. In FIG. 4B, an arrow 412 to an arrow 417 that are displayed at S11-021 are shown. The orientation of the arrow that is displayed in the rearrangement-target icon will be described later (see FIG. 12).

At S11-022, the CPU 101 finds the value of a drop area by performing computing. The specific processing is the same as that at S11-016.

At S11-023, the CPU 101 determines whether the computing results of the value of the drop area are valid. In a case where the determination results at this step are affirmative, the processing advances to S11-024. On the other hand, in a case where the determination results at this step are negative, the processing returns to S11-003.

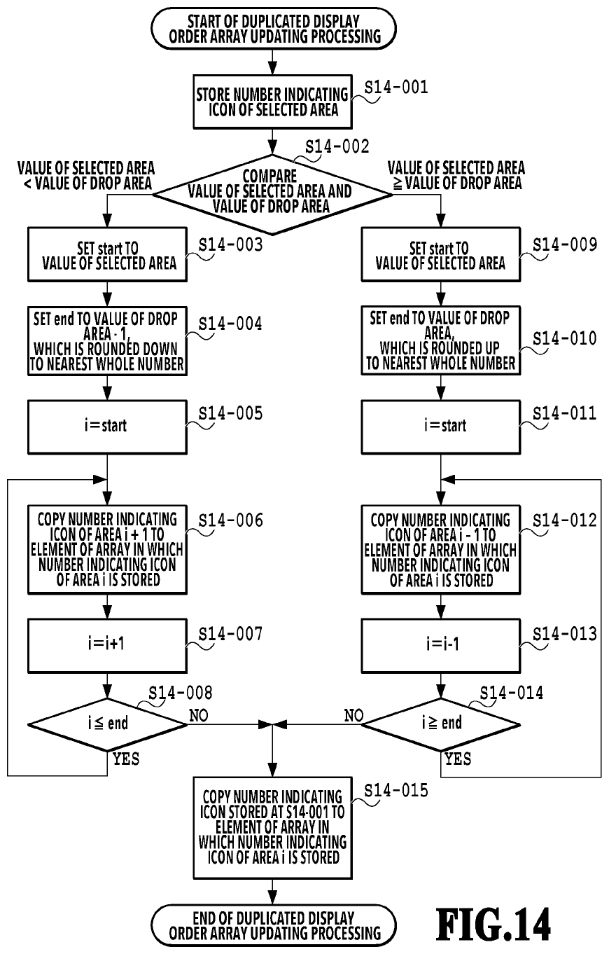

At S11-024, the CPU 101 updates the display order array duplicated at S11-001 based on the value of the selected area and the value of the area in which the icon is dropped. Details of this step will be described later (see FIG. 14).

### <Flowchart of Rearrangement-Target Icon Selection Processing>

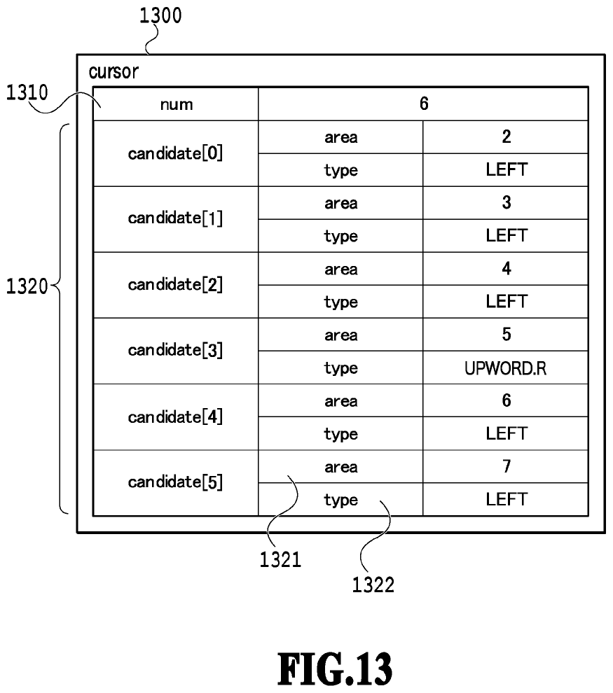

In the following, the rearrangement-target icon selection processing that is performed at S11-019 is explained by using FIG. 12 and FIG. 13. FIG. 12 is a detailed flowchart of the rearrangement-target icon selection processing at S11-019. FIG. 13 is a diagram showing an example of a data structure storing information on rearrangement-target icons, which is generated in the rearrangement-target icon selection processing. By the CPU 101 executing a part of the programs configuring the UI unit 202 in FIG. 2, the processing in FIG. 12 is performed.

As shown in FIG. 13, rearrangement-target icon information cursor (1300) includes a number cursor. num (1310) of rearrangement candidate icons. Further, the rearrangement-target icon information cursor (1300) includes cursor. candidate [0] to cursor. candidate [cursor. num (1310)−1], which is a list (1320) of rearrangement candidate icons. Furthermore, each candidate cursor. candidate [i] configuring the list (1320) of rearrangement candidate icons includes area information area (1321) and orientation information type (1322).

First, at S12-001, the CPU 101 determines a magnitude relationship between the value of the selected area and the value of the insertion candidate area. Specifically, as regards the magnitude relationship between the value of the selected area and the value of the insertion candidate area in the display order array 900, in a case where it is determined that the value of the insertion candidate area is larger than the value of the selected area, the processing advances to S12-002. On the other hand, in a case where it is determined that the value of the insertion candidate area is less than or equal to the value of the selected area, the processing advances to S12-013.

At S12-002 to S12-004, the CPU 101 performs initialization for performing the rearrangement-target icon selection processing in a case where the value of the insertion candidate area is larger than the value of the selected area.

At S12-002, the CPU 101 sets a parameter start indicating the start position of the rearrangement-target icon selection processing to the value of the selected area+1.

At S12-003, the CPU 101 sets a parameter end indicating the end position of the rearrangement-target icon selection processing to the value of the insertion candidate area, which is rounded down to the nearest whole number.

At S12-004, the CPU 101 sets an index i for the subsequent processing to start and an index j to 0.

At S12-005, the CPU 101 sets i to rearrangement candidate area information candidate [j]. area.

At S12-006 to S12-010, the CPU 101 performs processing for setting information on the orientation of the arrow for the rearrangement candidate icon in a case where the value of the insertion candidate area is larger than the value of the selected area.

At S12-006, the CPU 101 sets to what number page the icon of the area i belongs. Specifically, the CPU 101 sets the page number to which the icon of the area i belongs as the value of p.

At S12-007, the CPU 101 determines the orientation of the arrow for the rearrangement candidate icon in accordance with the index i and the target page number p. In a case where i coincides with 5+8 (p−1), that is, in a case where the position of the rearrangement candidate area corresponds to the position at the leftmost end in the lower row of each page, the processing advances to S12-008. Alternatively, in a case where i coincides with 1+8 (p−1), that is, the position of the rearrangement candidate area corresponds to the position at the leftmost end in the upper row of each page, the processing advances to S12-009. Alternatively, in a case where i does not coincide with 5+8 (p−1) or 1+8 (p−1), the processing advances to S12-010.

At S12-008, the CPU 101 sets a value UPWARD. R indicating the upper-rightward orientation to rearrangement candidate orientation information candidate [j]. type. Due to this, the orientation of the arrow that is displayed in the rearrangement candidate icon indicates the upper-rightward direction.

At S12-009, the CPU 101 sets a value DOWNWARD. L indicating the lower-leftward orientation to the rearrangement candidate orientation information candidate [j]. type. Due to this, the orientation of the arrow that is displayed in the rearrangement candidate icon indicates the lower-leftward direction.

At S12-010, the CPU 101 sets a value LEFT indicating the leftward orientation to the rearrangement candidate orientation information candidate [j]. type. Due to this, the orientation of the arrow that is displayed in the rearrangement candidate icon indicates the leftward direction.

At S12-011, the CPU 101 adds 1 to the index i and the index j.

At S12-012, the CPU 101 determines whether the index i is less than or equal to end that is set at S12-003. In a case where the determination results at this step are affirmative, the processing returns to S12-005. On the other hand, in a case where the determination results at this step are negative, the processing advances to S12-024.

As above, the rearrangement-target icon selection processing in a case where the value of the insertion candidate area is larger than the value of the selected area and the orientation determination of the arrow that is displayed therein are performed.

At S12-013 to S12-015, the CPU 101 performs initialization for performing the rearrangement-target icon selection processing in a case where the value of the insertion candidate area is less than or equal to the value of the selected area.

At S12-013, the CPU 101 sets the parameter start indicating the start position of the rearrangement-target icon selection processing to the value of the insertion candidate area, which is rounded up to the nearest whole number.

At S12-014, the CPU 101 sets the parameter end indicating the end position of the rearrangement-target icon selection processing to the value of the selected area−1.

At S12-015, the CPU 101 sets the index i to start and sets the index j to 0.

At S12-016, the CPU 101 sets i to the rearrangement candidate area information candidate [j]. area.

At S12-017 to S12-021, the CPU 101 performs processing for setting information on the orientation of the arrow that is displayed in the rearrangement candidate icon in a case where the value of the insertion candidate area is less than or equal to the value of the selected area.

At S12-017, the CPU 101 sets to what number page the icon of the area i belongs. Specifically, the CPU 101 sets the page number to which the icon of the area i belongs as the value of p.

At S12-018, the CPU 101 determines the orientation of the arrow that is displayed in the rearrangement candidate icon in accordance with the index i and the target page number p. In a case where i coincides with 8+8 (p−1), that is, in a case where the position of the rearrangement candidate area corresponds to the position at the rightmost end in the lower row of each page, the processing advances to S12-019. Alternatively, in a case where i coincides with 4+8 (p−1), that is, the position of the rearrangement candidate area corresponds to the position at the rightmost end in the upper row of each page, the processing advances to S12-020. Alternatively, in a case where i does not coincide with 8+8 (p−1) or 4+8 (p−1), the processing advances to S12-021.

At S12-019, the CPU 101 sets a value UPWARD. R indicating the upper-rightward orientation to rearrangement candidate icon orientation information candidate [j]. type. Due to this, the orientation of the arrow that is displayed in the rearrangement candidate icon indicates the upper-rightward direction.

At S12-020, the CPU 101 sets a value DOWNWARD. L indicating the lower-leftward orientation to the rearrangement candidate icon orientation information candidate [j]. type. Due to this, the orientation of the arrow that is displayed in the rearrangement candidate icon indicates the lower-leftward direction.

At S12-021, the CPU 101 sets a value RIGHT indicating the rightward orientation to the rearrangement candidate icon orientation information candidate [j]. type. Due to this, the orientation of the arrow that is displayed in the rearrangement candidate icon indicates the rightward direction.

At S12-022, the CPU 101 adds 1 to the index i and the index j.

At S12-023, the CPU 101 determines whether the index i is less than or equal to the parameter end indicating the end position of the icon selection processing. In a case where the determination results at this step are affirmative, the processing returns to S12-016. On the other hand, in a case where the determination results at this step are negative, the processing advances to S12-024.

As above, the rearrangement-target icon selection processing in a case where the value of the insertion candidate area is less than or equal to the value of the selected area and the orientation determination of the arrow that is displayed therein are performed.

At S12-024, the CPU 101 sets the number cursor. num (1310) of rearrangement candidate icons to j and terminates the rearrangement-target icon selection processing.

By the processing explained so far, the rearrangement-target icon is derived. At S11-021 in FIG. 11 described previously, the arrow is displayed in the rearrangement-target icon based on the rearrangement-target icon information cursor (1300) in FIG. 13 generated by the rearrangement-target icon selection processing in FIG. 12. For example, as on the screen 410 in FIG. 4B, in a case where the icon 301 located at the leftmost end in the upper row is being dragged to the position of the vertical rod 411 indicating the insertion position, the rearrangement-target icon selection processing shown in FIG. 12 is performed. By the rearrangement-target icon selection processing that has been performed, the rearrangement-target icon information cursor (1300) shown in FIG. 13 is generated. At S11-021 in FIG. 12, based on candidate [j]. area and candidate [j]. type, the CPU 101 displays the leftward arrows 412 to 414, 416 to 417 in the area 2 to the area 4 and the area 6 to the area 7. Further, at the same step, the CPU 101 displays the upper-rightward arrow 415 in the area 5.

### <Flowchart of Duplicated Display Order Array Updating Processing>

In the following, duplicated display order array updating processing that is performed at S11-024 described previously is explained by using FIG. 14. FIG. 14 is a detailed flowchart of the duplicated display order array updating processing at S11-024 in FIG. 11. The processing in FIG. 14 is performed by the CPU 101 executing a part of the programs configuring the UI unit 202 in FIG. 2.

At S14-001, the CPU 101 temporarily stores the number indicating a tapped-in icon in the RAM 103. For example, in the example of the screen 410 in FIG. 4B, 301 is stored temporarily in the RAM 103.

At S14-002, the CPU 101 determines a magnitude relationship between the value of the selected area and the value of the icon drop area. Specifically, as regards the magnitude relationship between the value of the selected area and the value of the drop area in the display order array 900, in a case where it is determined that the value of the drop area is larger than the value of the selected area, the processing advances to S14-003. On the other hand, in a case where it is determined that the value of the drop area is less than or equal to the value of the selected area, the processing advances to S14-009.

At S14-003 to S14-005, the CPU 101 performs initialization for performing the duplicated display order array updating processing in a case where the value of the drop area is larger than the value of the selected area.

At S14-003, the CPU 101 sets the parameter start indicating the start position of the duplicated display order array updating processing to the value of the selected area.

At S14-004, the CPU 101 sets the parameter end indicating the end position of the duplicated display order array updating processing to the value of the drop area−1, which is rounded down to the nearest whole number.

At S14-005, the CPU 101 sets the index i to start.

At S14-006, the CPU 101 copies the number indicating the icon of the area i+1 in the display number array 900 to the element of the array in which the number indicating the icon of the area i is stored. For example, in a case where the icon is dropped at the position of the vertical rod 411 indicating the insertion position on the screen 410 in FIG. 4B, first, a number 302 indicating the icon of the area 2 in the display order array 900 in FIG. 9 is copied to the element of the array in which the number indicating the icon of the area 1 is stored.

At S14-007, the CPU 101 adds 1 to the index i.

At S14-008, the CPU 101 determines whether the index i is less than or equal to the parameter end indicating the end position of the duplicated display order array updating processing. In a case where the determination results at this step are affirmative, the processing returns to S14-006. On the other hand, in a case where the determination results at this step are negative, the processing advances to S14-015.

At S14-009 to S14-011, the CPU 101 performs initialization for performing the duplicated display order array updating processing in a case where the value of the drop area is less than or equal to the value of the selected area.

At S14-009, the CPU 101 sets the parameter start indicating the start position of the duplicated display order array updating processing to the value of the selected area.

At S14-010, the CPU 101 sets the parameter end indicating the end position of the updating processing to the value of the drop area+1, which is rounded up to the nearest whole number.

At S14-011, the CPU 101 sets the index i to start.

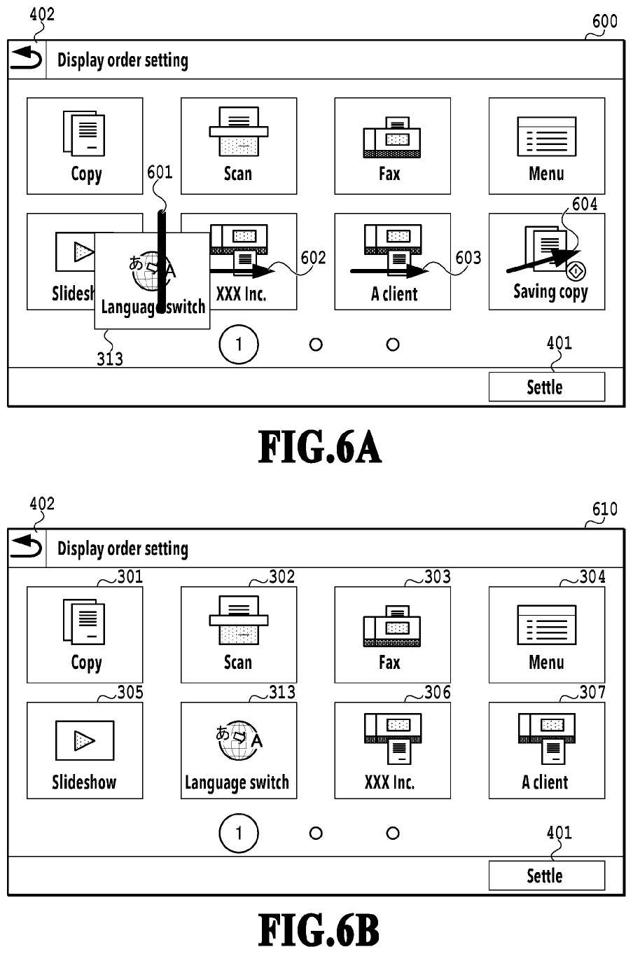

At S14-012, the CPU 101 copies the number indicating the icon of the area i−1 in the display order array 900 to the element of the array in which the number indicating the icon of the area i is stored. For example, in a case where an icon is dropped at an insertion position 601 on a screen 600 in FIG. 6A, to be described later, first, a number 312 indicating the icon of the area 10 in the display order array 900 in FIG. 9 is copied to the element of the array in which the number indicating the icon of the area 11 is stored.

At S14-013, the CPU 101 subtracts 1 from the index i.

At S14-014, the CPU 101 determines whether the index i is larger than or equal to the parameter end indicating the end position of the duplicated display order array updating processing. In a case where the determination results at this step are affirmative, the processing returns to S14-012. On the other hand, in a case where the determination results at this step are negative, the processing advances to S14-015.

At S14-015, the CPU 101 copies the number indicating the icon, which is stored temporarily in the RAM 103 at S14-001, to the element of the array in which the number indicating the icon of the area i is stored and terminates the duplicated display order array updating processing. For example, in a case where the icon is dropped at the insertion position 411 on the screen 410 in FIG. 4B, a number 301 indicating the icon is copied to the element of the array in which the number indicating the icon of the area 7 is stored.

<Display Screen after Dropping Icon and Screen after Further Pressing Down Settle Button 401 after That>

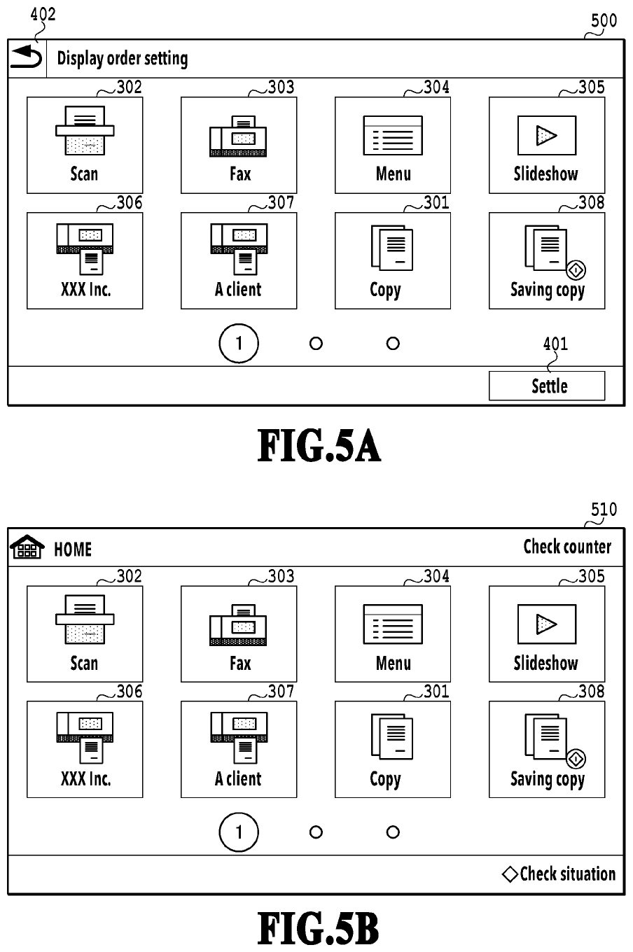

FIG. 5A is a diagram showing results of dropping an icon in the state of the screen 410 in FIG. 4B. FIG. 5B is a diagram showing a screen that is displayed in a case where the Settle button 401 is further pressed down after that.

In a case where an icon is dropped in the state of the screen 410 in FIG. 4B, by the processing in FIG. 14, the duplicated display order array is updated and at S11-003 in FIG. 11, the CPU 101 displays a screen 500 in FIG. 5A on the display unit 105. As shown on the screen 500, in a case where an icon is dropped in the state of the screen 410, the icon 302 to the icon 307 move to the areas whose value is one smaller, respectively, and in the area 7, the icon 301 is displayed. In a case where the Settle button 401 is pressed down in the state of the screen 500, at S11-006, the CPU 101 overwrites the original display order array 900 by the display order array duplicated at S11-001. Further, the CPU 101 updates the first page 300 on the HOME screen in FIG. 3A to a screen 510 in FIG. 5B. On the other hand in a case where the back button 402 is pressed down in the state of the screen 500, the icon display order is not changed and on the display unit 105, the first page 300 on the HOME screen in FIG. 3A is displayed.

<Display Screen in a Case where Tapped-in Icon is Dragged Across Pages>

FIG. 6A and FIG. 6B are each a diagram that is displayed in a case where the icon that is tapped in at S11-010 to S11-012 is dragged across pages.

The screen 600 in FIG. 6A is a screen that is displayed in a case where the icon 313 that is displayed on the second page 310 on the HOME screen in FIG. 3B is dragged to the position of the vertical rod 601 indicating the insertion position.

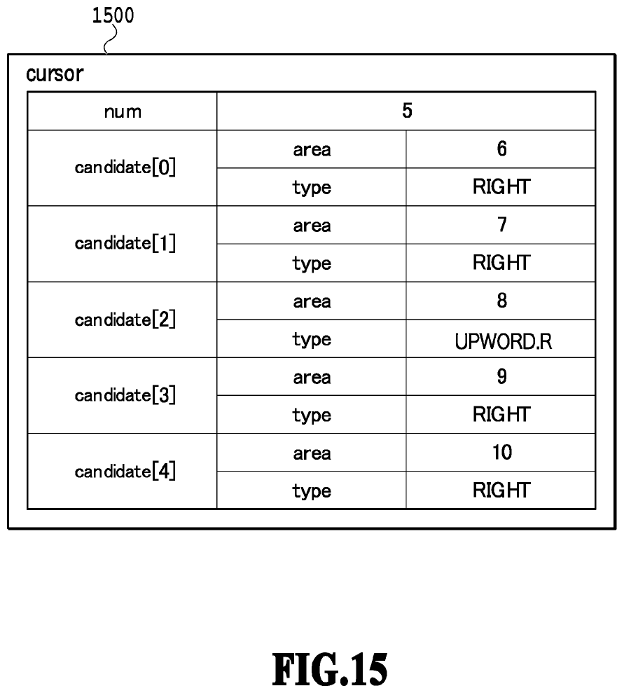

By this drag operation, S12-013 to S12-023 are performed and rearrangement-target icon information cursor (1500) shown in FIG. 15 is generated. Further, at S11-020, the vertical rod 601 indicating the insertion position is displayed. Furthermore, at S11-021, based on the rearrangement-target icon information cursor (1500), an arrow 602 to an arrow 604 on the screen 600 are displayed.

In the rearrangement-target icon information cursor (1500), information on rearrangement-target icons that are displayed in the area 9 and the area 10 is included. However, the display-target page is the first page, and therefore, reading of the data of candidate [3] and candidate [4] corresponding to the rearrangement-target icons displayed in the area 9 and the area 10 located on the second page is skipped.

In a case where an icon is dropped in the state of the screen 600, the display order array duplicated by the processing in FIG. 14 is updated and at S11-003 in FIG. 11, a screen 610 in FIG. 6B is displayed as the first page. As shown on the screen 610, in a case where an icon is dropped in the state of the screen 600, the icon 306 and the icon 307 move to the areas whose values are one larger, respectively, and in the area 6, the icon 313 is displayed.

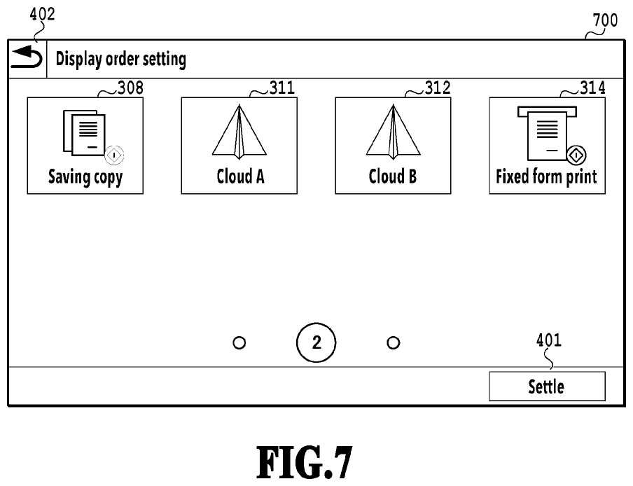

FIG. 7 is a diagram showing a case where the page switching operation is performed in the state of the screen 610 in FIG. 6B and a screen 700 is displayed as the second page.

In a case where the page switching operation is performed in the state of the screen 610 and S11-007 to S11-008 in FIG. 11 are performed, the screen 700 is displayed. As shown on the screen 700, in a case where an icon is dropped in the state of the screen 600, the icon 311 and the icon 312 move the areas whose values are one larger, respectively, and the icon 308 having been displayed in the area 8 on the screen 600 moves to the area 9 on the screen 700.

### <Effects of the Present Embodiment>

As explained so far, in the MFP 10 in the present embodiment, in a case where icons are rearranged by the drag and drop operation, it is made possible to indicate one or more rearrangement-target icons to a user, including the moving direction, without producing an animation display.

### Other Embodiments

In the first embodiment, as shown on the screen 410 in FIG. 4B, one or more rearrangement-target icons are indicated to a user, with the moving direction also being included, by displaying the arrow in the rearrangement-target icon. However, the mark or the symbol indicating that the icon is a rearrangement-target icon is not required to be an arrow. For example, the mark or the symbol indicating that the icon is a rearrangement-target icon may be a triangle having the vertex in the moving direction.

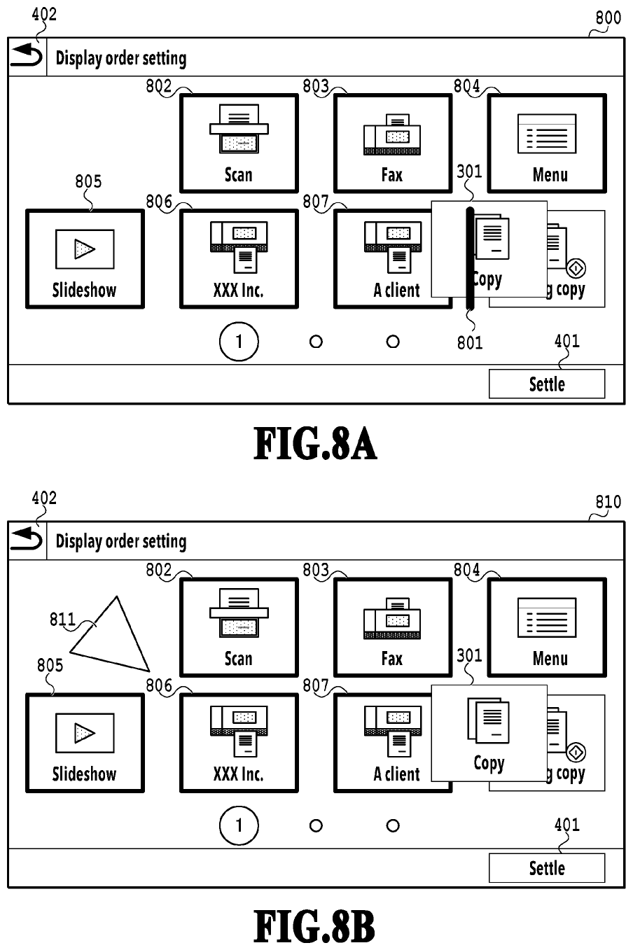

Further, the mark or the symbol indicating that the icon is a rearrangement-target icon may not include the information on the moving direction. FIG. 8A and FIG. 8B are each a diagram showing an embodiment in a case where the mark indicating that the icon is a rearrangement-target icon does not include the information on the moving direction. In the embodiment shown in FIG. 8A and FIG. 8B, as the mark indicating that the icon is a rearrangement-target icon, the outer frame of the icon is used. As in this embodiment, in a case where the mark or the symbol indicating that the icon is a rearrangement-target icon does not include the moving direction, in the processing in FIG. 12, it is not necessary to comprise S12-006 to S12-010 and S12-017 to S12-021. Further, in this embodiment, it is not necessary for the rearrangement-target icon information cursor (1300) shown in FIG. 13 to have the orientation information type (1322). In FIG. 8A and FIG. 8B, the embodiment is shown in which the mark indicating that the icon is a rearrangement-target icon is the outer frame of the icon. The mark indicating that the icon is a rearrangement-target icon is not limited to this. For example, it may also be possible to indicate that the icon is a rearrangement-target icon by changing the background color, making the entire icon transparent, and so on. Further, it may also be possible to take a blank icon area in which no icon is displayed as a rearrangement target or not to take as a rearrangement target.

Further, in order to indicate the icon insertion position at which the drag and drop operation is performed to a user, in the first embodiment, the simple vertical rod, such as 411 in FIG. 4B, 601 in FIG. 6A, and 801 in FIG. 8A, is displayed. However, the means of indicating the icon insertion position to a user is not limited to this. For example, the shape of the mark indicating the insertion position may be an isosceles triangle 811 whose vertex is located on the left side on the screen and at the center in the vertical direction shown in FIG. 8B.

Further, one embodiment of the present invention is not limited to the icon rearrangement in a case where there is no seam between pages. For example, one embodiment of the present invention may include a configuration in which it is possible to drop an icon only in a case where there is a blank within a page with the concept, such as that each page is an independent tab, and the icon rearrangement across pages is not performed. Specifically, in a case where an icon is dropped, on a condition that the rearrangement-target icon moves toward the blank nearest to the drop position, it is sufficient to display a mark or a symbol indicating that the icon is a rearrangement-target icon to the icon.

Further, in the first embodiment, the configuration is designed so that the processing moves to the display order setting processing in a case where the icon is held down as at S10-001 and S10-002. However, the means of moving to the display order setting processing is not limited to this. For example, it may also be possible to design a configuration in which in a case where the icon 304 displayed on the screen 300 in FIG. 3A is held down, the operation moves to the menu operation to perform various kinds of setting and in this menu, the display order setting is listed.

Further, one embodiment of the present invention is not limited to the MFP 10 in the first embodiment. For example, one embodiment of the present invention may include an apparatus or the like having a display unit configured to display a plurality of icons, an operation unit configured to perform the drag and drop operation for an icon, and a display control unit configured to additionally display a mark to an icon. As the apparatus such as that, mention is made of, for example, a home electrical appliance mounting a touch panel that displays an icon, and the like. A home electrical appliance mounting a touch panel is taken as an example, but one embodiment of the present invention may be one in which, for example, the operation unit is a device, such as a mouse.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to one embodiment of the present invention, it is made possible to indicate one or more rearrangement-target icons to a user separate from an icon being dragged.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-022175, filed Feb. 13, 2020, which is hereby incorporated by reference wherein in its entirety.

What is claimed is:

1. An apparatus comprising:
a derivation unit configured to derive one or more icons different from a first icon, which are rearrangement targets in a case where a drop operation is performed for the first icon during a drag operation of the first icon among icons displayed on a display unit; and
a display control unit configured to perform control so that the display unit additionally displays a first mark for the one or more icons derived by the derivation unit.

2. The apparatus according to claim 1, comprising:
a generation unit configured to generate information on a first position at which the first mark is displayed in a case where the drop operation is performed for the first icon during the drag operation of the first icon in the derivation unit.

3. The apparatus according to claim 2, comprising:
a generation unit configured to generate information on an orientation in which one or more icons move in a case where the drop operation is performed for the first icon during the drag operation of the first icon in the derivation unit.

4. The apparatus according to claim 3, wherein
the first mark has a shape indicating a direction based on the information on orientation.

5. The apparatus according to claim 3, wherein
the first mark is an arrow and indicates a direction based on the information on orientation.

6. The apparatus according to claim 1, comprising:
a generation unit configured to generate information on a second position at which the first icon is inserted in a case where the drop operation is performed for the first icon during the drag operation of the first icon in the derivation unit.

7. The apparatus according to claim 6, wherein
the display control unit performs control so that the display unit displays a second mark indicating, based on the information on the second position, a position at which the first icon is inserted in a case where the drop operation is performed for the first icon during the drag operation of the first icon.

8. The apparatus according to claim 1, wherein
a blank area in which no icon is displayed is a rearrangement target.

9. The apparatus according to claim 7, wherein
the display control unit performs, accompanying the drop operation of the first icon, control so that the display unit deletes the first mark and the second mark and displays the one or more icons rearranged based on the first mark and the first icon inserted based on the second mark.

10. A control method comprising:
a step of deriving one or more icons different from a first icon, which are rearrangement targets in a case where a drop operation is performed for the first icon during a drag operation of the first icon among icons displayed on a display unit; and
a step of performing control so that the display unit additionally displays a first mark for the one or more icons derived at the step of deriving the one or more icons.

11. A non-transitory computer-readable storage medium storing a program for causing a computer to perform a control method comprising:
a step of deriving one or more icons different from a first icon, which are rearrangement targets in a case where a drop operation is performed for the first icon during a drag operation of the first icon among icons displayed on a display unit; and
a step of performing control so that the display unit additionally displays a first mark for the one or more icons derived at the step of deriving the one or more icons.
